(19) United States
(12) Patent Application Publication
(10) Pub. No.: US 2008/0189211 A1
(43) Pub. Date: Aug. 7, 2008

(54) SYSTEM AND METHODS FOR PROCESSING CREDIT TRANSACTIONS

(76) Inventors: Elias Obadia, Miami Beach, FL (US); Jacob SERFATI, Aventura, FL (US)

Correspondence Address: AKERMAN SENTERFITT, P.O. BOX 3188, WEST PALM BEACH, FL, 33402-3188, US

(21) Appl. No.: 12/027,785

(22) Filed: Feb. 7, 2008

Related U.S. Application Data
(60) Provisional application No. 60/888,667, filed on Feb. 7, 2007.

(51) Int. Cl. G06Q 20/00

(52) U.S. Cl. 705/44

(57) ABSTRACT

A distributed computing system for processing a credit card transaction is provided. The computing system includes a first computer-readable storage medium in which computer-readable code is for directing a first computing device to process and transmit transaction information pertaining to a credit card from a first location to a second location through a communications network. The computing system also includes a second computer-readable storage medium in which computer-readable code is stored for directing a second computing device to (1) determine the identity of an authorized user of the credit card based upon the subscriber identifier, (2) establish a communications link with the authorized user, (3) provide to the authorized user through the established communications link the transaction amount and prompt the authorized user for a transaction authorization, (4) authorize the credit card transaction if the authorized user provides the transaction authorization, and (5) negate the credit card transaction if the authorized user does not provide the transaction authorization.

### CROSS-REFERENCE TO RELATED APPLICATION

This application claims the benefit of U.S. Provisional Application No. 60/888,667, filed on Feb. 7, 2007.

### FIELD OF THE INVENTION

The present invention is related to the field of data processing, and more particularly, to systems and methods for processing credit transactions without physically using a credit card and, additionally, for providing heightened security features for credit card owners and customers.

### BACKGROUND OF THE INVENTION

A credit card provides a credit card user with many conveniences, including obviating the need for cash to effect various types of commercial transactions. Nonetheless, the card user must typically carry a credit card in order to undertake these transactions. Because many credit card users own more than one credit card, a user typically must carry several credit cards if the user wishes to have the option of using different ones for particular transactions. Moreover, if a credit card user loses his or her credit card, there is the risk that the credit card will be found and used by an unauthorized user.

Accordingly, there is the need for a mechanism whereby a credit card user can obtain the benefits of subscribing to a credit card service without having to physically carry one or more credit cards. There is also the need for a mechanism whereby the credit card user can better safeguard against the unauthorized use of a credit card that is lost or stolen. Additionally, there is a need for a more efficient and convenient mechanism for providing a credit card user with transaction data.

### SUMMARY OF THE INVENTION

The present invention is directed to a system and related methods for effecting credit card transactions without the need for a credit card subscriber to physically carry and present the credit card to a merchant. The present invention is also directed to a system and related methods that provide heightened security features for protecting against the unauthorized use of a credit card. The present invention, additionally, can provide the credit card subscriber with convenient access to stored information relating to credit card transactions.

One embodiment of the invention is a system for processing credit card transactions. The system can include a terminal processing module that is configured to receive and transmit transaction information, the transaction information can include a transaction amount and a subscriber identifier. The system also can include a central processing unit communicatively linked to the terminal processing module. The central processing unit, more particularly, can be configured to receive transaction information transmitted by the terminal processing module and can include a database comprising a plurality of subscriber records. Each subscriber record can include an access number corresponding to the subscriber identifier. The central processing unit can further include a module, defining a central processing module. The central processing module can be configured to access the database in response to received transaction information, to initiate a communication to a selected subscriber corresponding to the subscriber identifier, and to authorize or deny a transaction based upon a response received by the selected subscriber.

Another embodiment of the invention is a method of processing credit card transactions. The method can include processing and transmitting transaction information pertaining to a credit card from a first location to a second location through a communications network. The transaction information can include a transaction amount and a subscriber identifier provided by a system user. The method also can include determining at the second location the identity of an authorized user of the credit card based upon the subscriber identifier, and establishing a communications link with the authorized user. Additionally, the method can include providing to the authorized user, through the established communications link, the transaction amount, and prompting the authorized user for a transaction authorization. The method further can include authorizing the credit card transaction if the authorized user provides the transaction authorization, or negating the credit card transaction if the requested transaction authorization is not provided.

Yet another embodiment of the invention is a distributed computing system for processing a credit card transaction. The computing system can include a first computer-readable storage medium in which computer-readable code is stored for directing a first computing device to process and transmit transaction information pertaining to a credit card from a first location to a second location through a communications network. The computing system also can include a second computer-readable storage medium having computer-readable code stored thereon for directing a second computing device to (1) determine the identity of an authorized user of the credit card based upon the subscriber identifier, (2) establish a communications link with the authorized user, (3) provide to the authorized user through the established communications link the transaction amount and prompt the authorized user for a transaction authorization, (4) authorize the credit card transaction if the authorized user provides the transaction authorization, and (5) negate the credit card transaction if the transaction authorization is not provided.

### BRIEF DESCRIPTION OF THE DRAWINGS

There are shown in the drawings, embodiments which are presently preferred. It is expressly noted, however, that the invention is not limited to the precise arrangements and instrumentalities shown.

FIG. 1 is a schematic view of a system for processing credit card transactions, according to one embodiment of the invention.

FIG. 2 is a schematic view of central processing unit included in the system of FIG. 1.

FIG. 3 is a flowchart of exemplary steps of a method for processing credit card transactions, according to another embodiment of the invention.

### DETAILED DESCRIPTION

The invention is directed to systems and methods for facilitating the use of a credit card without the user having to physically carry and present to a merchant the actual credit card. The invention additionally can provide the user of a credit card with safeguards against the unauthorized use of the credit card. Still another aspect of the invention is a mechanism to provide the user of the credit card with convenient access to current transaction data related to the credit card.

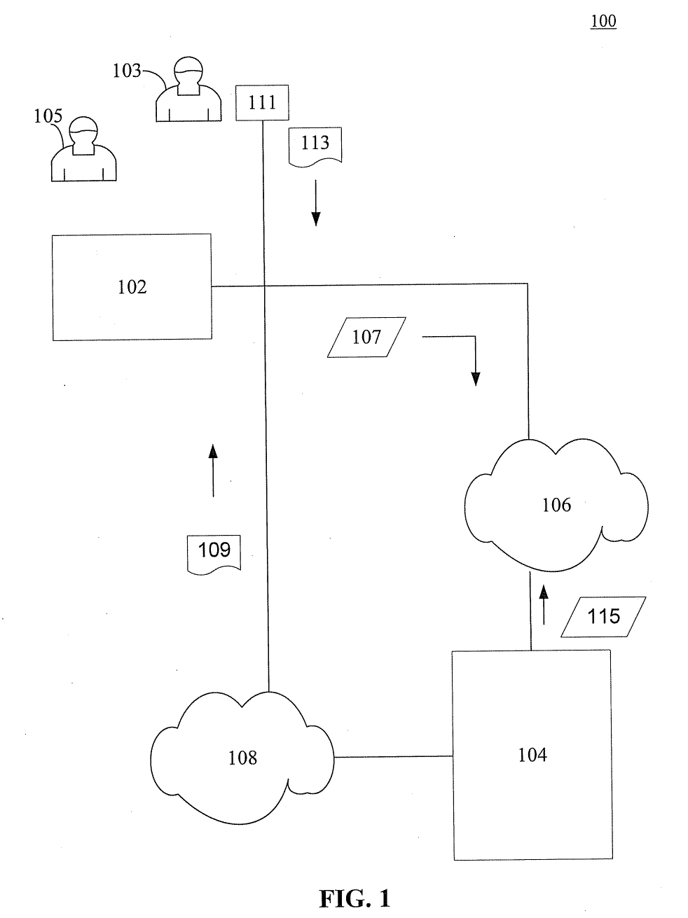

FIG. 1 is a schematic view of a system 100 for processing credit card transactions, according to one embodiment of the invention. The system 100 illustratively includes a terminal processing module 102 configured to receive and transmit transaction information, which can include a transaction amount and a subscriber identifier. The transaction information optionally can also include a credit card number for a credit card service subscriber. Additionally, the system 100 illustratively includes a central processing unit 104 communicatively linked to the terminal processing module 102, the central processing unit being configured to receive and process the transaction information transmitted by the terminal processing module.

The terminal processing module 102 can comprise dedicated hardwired circuitry, such as circuit board that connects to another device (not explicitly shown) by, for example, plugging into a connector or slot of the other device. Alternatively, the terminal processing module 102 can comprise computer-readable code configured to execute on the logic processing circuitry of an application-specific or general purpose computer. In still another embodiment, the terminal processing module 102 can comprise a combination of dedicated hardwired circuitry and computer-readable code.

Accordingly, in one embodiment, the terminal processing module 102 comprises an add-on to a conventional credit card processing device utilized by a merchant. Operating as an add-on, in the form of circuitry and/or computer-readable code, the terminal processing module 102 operates cooperatively with the central processing unit 104 to effect credit card transactions in the manner described herein. In particular, the terminal processing module 102 can read account information encoded on a credit card when it is run through the merchant credit card processing device. The terminal processing module 102 can then cause the transaction information to be conveyed to the central processing unit 104. Implemented as computer-readable code, the terminal processing module 102 acts much like a filter that comprises an additional layer added to software code running on a merchant's credit card processing device. In any event, if a customer wishes to effect a transaction by actually presenting a credit card to the merchant, the transaction can be processed just as any standard credit card transaction would be processed.

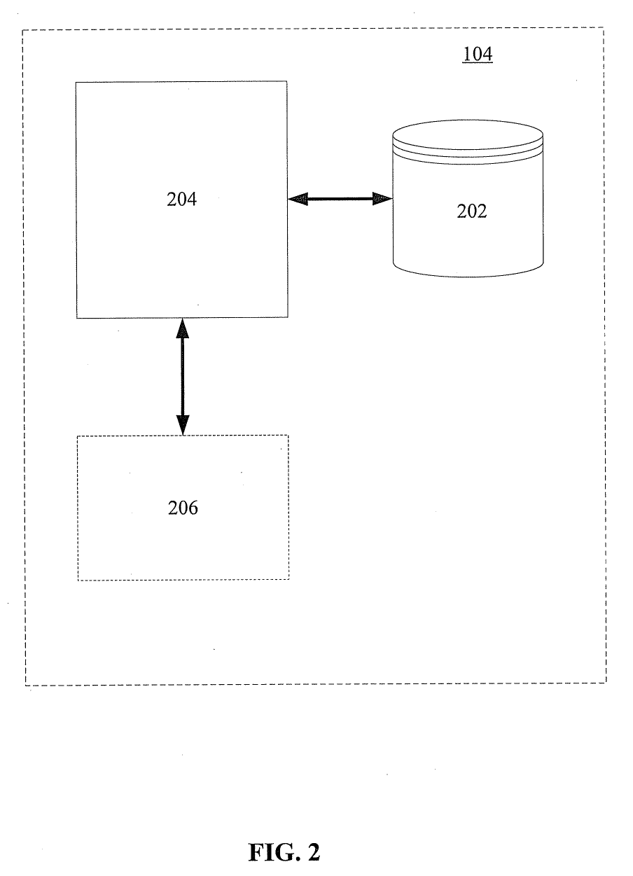

Referring additionally to FIG. 2, one embodiment of the central processing unit 104 includes a database 202 comprising a plurality of subscriber records. Each such record comprises at least one field, and preferably multiple fields. One field can record an access number, such as a telephone number, or an address, such as an IP address, corresponding to the subscriber identifier, which is stored in another field. Accordingly, the database can comprise multiple records that each comprise one field containing the subscriber identifier and one or more others containing the corresponding access number or address. For example, another field can include one or more credit card numbers for a particular credit card service subscriber. As described more particularly hereinafter, each such record can comprise more than two fields for storing various forms and types of data corresponding to each particular subscriber identifier.

Additionally, the central processing unit 104 illustratively includes a central processing module 204. Operatively, the central processing module 204 is configured to access the database 202 in response to received transaction information and to initiate a communication to a selected subscriber corresponding to the subscriber identifier. The central processing module is further configured to authorize or deny a transaction based upon a response received by the selected subscriber. The central processing module 204 can be implemented as dedicated hardwired circuitry, as computer-readable code configured to execute on an application-specific or general-purpose computer, or as a combination of circuitry and computer-readable code.

As further illustrated, the central processing unit 104 can be communicatively linked to the terminal processing module 102 through a communications network 106. The communications network 106 can be, for example, a data communications network such as the Internet, a wide-area network (WAN), a local-area network (LAN), or other communications network for exchanging packet-switched data. Alternatively, communications network 106 can be a wired or wireless telephone network.

Regardless of the particular type of communications network 106 utilized, the terminal processing module 102 conveys transaction information 107, which as already noted can include a transaction amount and a subscriber identifier, to the central processing unit 104 through the communications network. In a particular embodiment, a credit card subscriber 103 provides the merchant 105 with a telephone number, such as the calling number of a mobile telephone. The telephone number functions as the subscriber identifier for the particular credit card user. The merchant 105 then enters the telephone number, along with the amount of the transaction, into the merchant credit card processing unit on which the terminal processing unit 102 executes. The central processing unit 104 intercepts the transaction information 107 and correlates the information with the information stored in the database 202.

Optionally, the central processing unit 104 can determine whether the subscriber 103 has sufficient funds allocated to his or her credit account to cover the transaction. The central processing unit 104 optionally can determine whether a credit limit would be exceed by the amount of the transaction. Any other current information regarding the subscriber's credit card account can optionally be determined by the central processing unit 104. The central processing unit 104 can be configured to identify certain conditions, such as a suspicious transaction, and to alert the subscriber through any of the communication mechanisms subsequently described prior to the subscriber completing the transaction.

The central processing unit 104 then initiates a communication 109 to the subscriber by placing a call to the same or a different telephone number corresponding to the particular subscriber 103. When a subscriber identified by the central processing unit 104 receives the communication, for example, by a call to a telephone device 111 such as a mobile phone, the subscriber 103 can authorize or negate the transaction by sending a response communication 113 to the central processing unit. According to one embodiment, a call to the subscriber 103 and the response from the subscriber to the central processing unit 104 are conveyed over a separate telephone network 108, such as a wireless cellular or mobile network. Thus, according to this embodiment, the subscriber 103 can authorize or negate a transaction with either a voice response or keypad entry using the telephone device 111. If the subscriber 103 authorizes the transaction, the transaction can be logged by the central processing unit 104 in the database 202 and/or in a separate database co-located with or remotely located from the central processing unit 104.

Optionally, the central processing unit 104 can include an interactive voice response (IVR) system 206 that communicates with the subscriber 103 when the central processing unit 104 initiates a communication to the telephone device 111. In other embodiments, however, the communication can be made by a human operator. A security feature of the system 100 is the storing in the database 202 of a password or code corresponding to the subscriber 103. Accordingly, to authorize a purchase for a particular amount, the IVR system 206 or a human operator can request the password or code from the subscriber. Other security features can be utilized. Regardless of the security feature utilized, the security feature can be configured so that it can be enabled and disabled at any time.

In one embodiment, the communication 109 to the subscriber initiated by the central processing unit 104 can cause the amount of the purchase to be displayed on a visual interface of a telephone device in lieu of a caller-id number that is a typical feature of such devices. The communication indicating the amount can also be conveyed to the subscriber 103 in the form of a voice signal over a public-switched, packet switched, or wireless telephone network. In either event, the amount of the transaction can be conveyed to the subscriber 103 before the subscriber is requested to provide the response communication 113, comprising a password or code, to the central processing unit 104 in order to authorize the transaction.

In lieu of a telephone device 111, other devices can be used for communications between the subscriber 103 and the central processing unit 104. For example, an alternative device can be a personal digital assistant (PDA) or a personal computer (PC) or similar such computing/communication device. Accordingly, the communication 109 to the subscriber 103 and/or the response communication 113 from the subscriber can comprise an e-mail message or other data communications conveyed over a packet-switched communications network.

This aspect of the invention can provide a particular advantage if the subscriber 103 wishes to allow someone else to use the credit card, without having to lend the card to the alternate user. For example, the subscriber 103 can instruct a son or daughter as to which subscriber identifier to provide to a merchant. The subscriber 103 can then be contacted at a designated telephone number or at an IP address even though the subscriber is not physically at the site where the son or daughter seeks to make a purchase that will be charged to the subscriber's credit card. Because the database 202 can contain multiple fields with different numbers, even if one number is given to the merchant, different telephone number or IP address corresponding to the particular subscriber 103 can be used by the central processing unit 104 to initiate communications with a subscriber. In such instances, the subscriber 103 is also be afforded the opportunity to be notified of an amount of a purchase prior to authorizing the charge to the subscriber's card.

Moreover, because the database 202 can contain multiple fields each corresponding to a particular subscriber identifier, each subscriber can store account information corresponding to different credit cards. Accordingly, the communication conveyed by the central processing unit 104 to the subscriber 103 can elicit a voice response or key entry for selecting which of the different credit cards the subscriber wishes to use to effect a particular transaction. For example, when the central processing unit 104 communicates with the subscriber 103 through the telephone device 111, the subscriber can select one of the different credit cards by entering one or more digits using the keypad of the device. Alternatively, the subscriber 103 can select a particular credit card with a voice response processed by the optional IVR system 206. Note that the subscriber 103, according to some of the alternative embodiments of the invention, need not specify the telephone number.

After the subscriber 103 has authorized the transaction for the given amount, the central processing unit 104 communicates a message 115 back to the terminal processing module 102. The message 115 authorizes or negates the transaction. When the transaction is authorized, the transaction is completed by charging the appropriate amount against the credit card account of the subscriber 103. Thus, the entire transaction can occur over a telephone or other communications network without the subscriber 103 ever having to physically present his or her credit card.

The message 115 additionally can specify which one of a plurality of different credit cards belonging to the subscriber 103 is to be charged for the specified amount of the transaction, as well as an appropriate authorization code. If the transaction is rejected by the subscriber 103, the message 115 optionally can contain information pertaining to the reason for the rejection.

The central processing unit 104, according to still another embodiment, can be configured to respond when the subscriber 103 negates a particular transaction by automatically reporting the attempted transaction as a possible fraud. The subscriber 103 can optionally elect to receive an additional communication, such as an e-mail, SMS Text Message, Instant Message, or a voice-based telephone message, whenever any use of a credit card owned by the subscriber is attempted. The additional communication can include information such as the time and date use of the subscriber's credit card was attempted and/or the amount of purchase that was to be charged.

As described, the system 100 thus permits the subscriber 103 to use a credit card for a credit transaction without physically presenting the credit card to a merchant. Optionally, however, the system 100 can be configured allow the subscriber 103 to physically use a credit card for which account information has already been stored by the system; that is, a credit card that has been previously registered with the system 100 by the subscriber 103. Specifically, the subscriber can run the previously registered credit through a standard merchant credit card processing device. The terminal processing module 102 then reads account information from the card and conveys the information to the central processing unit 104. The central processing unit 104, in turn, initiates a communication with the subscriber and the processing proceeds as already described.

Moreover, as also described, the system 100 allows the subscriber 103 to store account information corresponding to more than one credit card so that the subscriber can select from among a plurality of credit cards during a transaction. Additionally, however, the system 100 can be further configured to allow the subscriber 103 to register with the system 100 an additional credit card after having previously registered a different credit card. More particularly, according to one embodiment, the terminal processing module 102 can be configured to read account information when the subscriber 103 runs the previously registered credit card through a standard merchant credit card processing device. The account information is conveyed to the central processing unit 104, which is configured to determine whether the account information corresponds to the subscriber 103. If so, then the central processing unit 104 authorizes the subscriber 103 to enter new account information for a different credit card. Account information corresponding to the subscriber's new credit card is read by the terminal processing module 102 when the subscriber runs the credit card to be registered through the merchant credit card processing device. These features can operate so as to provide a subscriber virtual receipts that can replace conventional paper receipts.

In other embodiments, the system 100 is alternatively, or additionally, configured to allow the subscriber 103 to register a new credit card using a communications device that connects directly through a communications network to the central processing unit 104. The device and network can comprise, for example, a telephone linked to the central processing unit 104 through a public-switched telephone network. The device and network alternatively can comprise a wireless telephone linked to the processing unit 104 through a wireless, or cellular, network. In still other embodiments, the communications device can comprise a handheld device, such as a PDA or other computing or communication device. In yet other embodiments, the device and network can comprise a computing device such as PC or laptop computer that communicatively links to the central processing unit 104 through a data communications network, such as the Internet, a WAN, a LAN, or a wireless LAN.

Similarly, because the database 202 is able to store multi-field records that can be updated following each transaction by the subscriber 103, the system can be further configured to provide updatable transaction data to the subscriber when the subscriber communicates directly with the central processing unit 104 through a communications network, such as a wireless network, plain-old telephone service (POTS) network, or a data communications network. Access to transaction data stored by the system 100 can be denied unless a proper password or pass code is provided so as to protect the information against unauthorized use.

When a legitimate subscriber properly accesses the system 100, current information regarding transactions—both those authorized and those negated—can be provided by the central processing unit through a communications channel. The central processing unit 104 can be configured with dedicated circuitry and/or computer readable code so as to allow the network-connected subscriber to sort the transaction data, filter the data, and/or download or export the data. For example, the data can be exported to a conventional accounting software system or spreadsheet application. One advantage provided by the system 100, therefore, is that a subscriber need not wait to receive from a credit card service a periodic statement of transactions; the system 100 can be accessed directly, at any time, by a legitimate subscriber. Another distinct advantage is that the system 100 is that it can provide a subscriber who uses multiple credit cards a single source of data relating to transactions pertaining to each of the subscriber's credit cards.

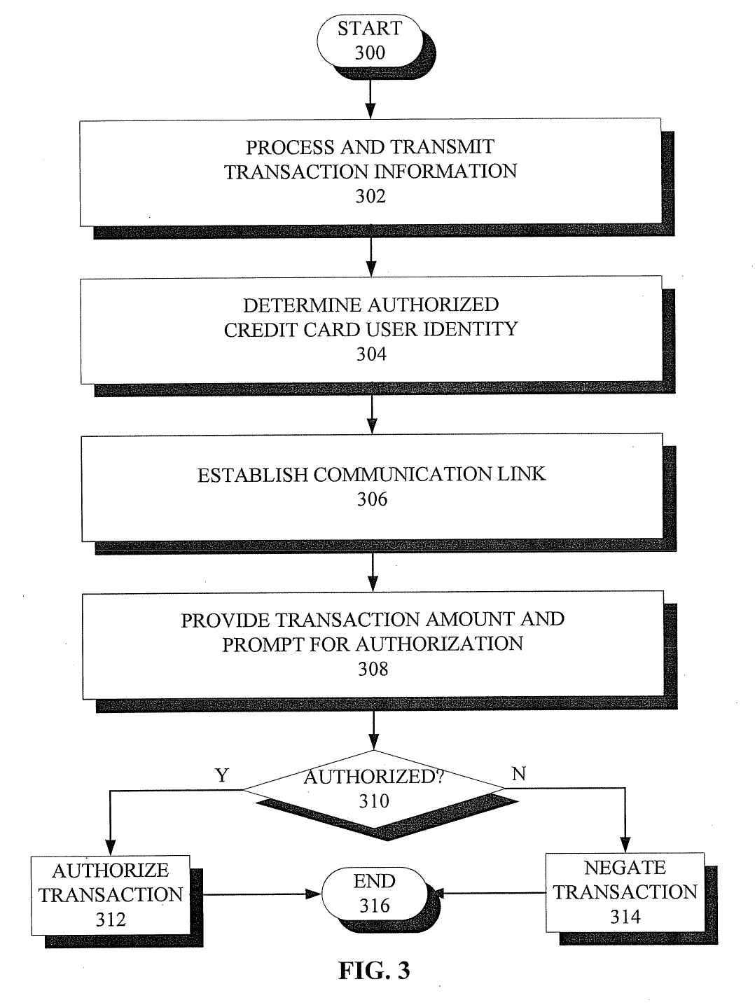

FIG. 3 is a flowchart of exemplary steps of a method 300 for processing credit card transactions, according to another embodiment of the invention. The method 300 illustratively includes processing and transmitting transaction information pertaining to a credit card from a first location to a second location through a communications network, at step 302. More particularly, the transaction information includes a transaction amount and a subscriber identifier provided by a system user. Additional information can include an identifier indicating a store or other establishment at which the transaction is to occur. At step 304, the method 300 further illustratively includes determining at the second location the identity of an authorized user of the credit card based upon the subscriber identifier.

Additionally, the method 300 illustratively includes, at step 306, establishing a communications link with the authorized user, and at step 308, providing to the authorized user, through the established communications link, the transaction amount and also prompting the authorized user for a transaction authorization. At step 310, a determination is made as to whether the authorized user consents to the transaction. If so, then at step 312 the the credit card transaction is authorized and a notice is conveyed to the first location. Otherwise, at step 314 the transaction is negated. The method 300 illustratively concludes at step 316.

The method 300, according to still another embodiment, further includes prompting the authorized user for a credit card selection, and charging the transaction amount to a user-selected credit card if the transaction authorization is provided. In another embodiment, the method 300 also includes storing transaction information, the transaction information further including a date the system user provided the subscriber identifier, the time the system user provided the subscriber identifier, and/or an indicator indicating whether or not the transaction authorization was provided.

According to yet another embodiment, the method 300 additionally includes prompting the system user for a pass code, and automatically notifying the authorized user if the pass code is incorrect. In still another embodiment, method 300 further includes storing transaction information corresponding to a plurality of transactions and providing the transaction information to the authorized user at a third location remote from the second location.

The invention described herein can be utilized in the context of Internet-based transactions using credit cards. In the context of bricks-and-mortar stores, a phone number is entered in the terminal processing module 102 by the merchant according to some embodiments. When engaged in an on-line transaction, a website usually is the point of transaction. Accordingly, in other embodiments of the invention, a credit card subscriber 103 who otherwise would enter his or her credit card number in the website, would instead with these embodiments enter a telephone number.

In some implementations, to effect better compatibility with pre-existing software and/or hardware, when entering a telephone number in the terminal processing module 102, or in the context of an on-line transaction involving a website, the telephone number can be preceded by a set of digits, similar to the use of a credit card in which the first 6 digits identify the entity that issued the credit card (i.e., issuer identifier). In this manner, the terminal processing module 102, or a website, can treat the telephone number just as a credit card and can send for the specific issuer identifier the transaction information to the central processing unit 104.

The invention, as already noted, can be realized in hardware, software, or a combination of hardware and software. The invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The invention, as also already noted, can be embedded in a computer program product, which comprises all the features enabling the implementation of the methods described herein, and which when loaded in a computer system is able to carry out these methods. Thus, for example, the computer program product can comprise a computer-readable disk in which is embedded computer-readable code, defining a computer program, for directing a computer to implement the methods described herein. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

The foregoing description of preferred embodiments of the invention have been presented for the purposes of illustration. The description is not intended to limit the invention to the precise forms disclosed. Indeed, modifications and variations will be readily apparent from the foregoing description. Accordingly, it is intended that the scope of the invention not be limited by the detailed description provided herein.

We claim:

1. A system for processing credit card transactions, the system comprising:
a terminal processing module configured to receive and transmit transaction information comprising a transaction amount and a subscriber identifier;
a central processing unit communicatively linked to said terminal processing module, said central processing unit configured to receive transaction information transmitted by said terminal processing module and including
a database comprising a plurality of subscriber records, each record comprising an access number corresponding to the subscriber identifier,
a central processing module configured to access said database in response to received transaction information, to initiate a communication to a selected subscriber corresponding to the subscriber identifier, and to authorize or deny a transaction based upon a response received by the selected subscriber.

2. The system of claim 1, wherein said terminal processing module is configured to reside on a credit-card processing terminal, to read account information encoded on a credit card, and to convey transaction information that includes the account information to the central processing unit.

3. The system of claim 2, wherein the central processing unit is configured to determine whether the account information corresponds to a subscriber, and, if the account information corresponds to a subscriber, then (1) to initiate a communication with the subscriber corresponding to the account information and (2) to authorize or deny a credit transaction based upon a response communicated to the central processing unit by the subscriber corresponding to the account information.

4. The system of claim 2, wherein the central processing unit is configured to determine whether the account information corresponds to a subscriber, and, if the account information corresponds to a subscriber, then to authorize the subscriber to enter new account information for a different credit card.

5. The system of claim 1, wherein said terminal processing module and said central processing unit are each configured to communicate with one another through a data communications network.

6. The system of claim 1, wherein said terminal processing module and said central processing unit are each configured to communicate with one another through a wireless communication channel.

7. The system of claim 1, wherein said central processing unit further comprises a interactive voice response system communicatively linked to said central processing module for generating at least one voice-based prompt that is conveyed to the selected subscriber.

8. The system of claim 1, wherein said central processing unit further comprises a transaction database in communicatively linked to said central processing module for storing transaction data, said central processing module being further configured to update said transaction database after a credit card transaction is completed or nullified by the selected subscriber.

9. The system of claim 8, further comprising an interface configured to provide updatable transaction data to a remotely located subscriber through a communications network.

10. The system of claim 9, wherein the communications network comprises at least one of a data communications network and a wireless communications network.

11. A method of processing a credit card transaction, the method comprising the steps of:
processing and transmitting transaction information pertaining to a credit card from a first location to a second location through a communications network, wherein the transaction information includes a transaction amount and a subscriber identifier provided by a system user;
determining at the second location the identity of an authorized user of the credit card based upon the subscriber identifier;
establishing a communications link with the authorized user;
providing to the authorized user through the established communications link the transaction amount and prompting the authorized user for a transaction authorization;
authorizing the credit card transaction if the authorized user provides the transaction authorization; and
negating the credit card transaction if the authorized user does not provide the transaction authorization.

12. The method of claim 11, further comprising the step of prompting the authorized user for a credit card selection and charging the transaction amount to a user-selected credit card if the transaction authorization is provided.

13. The method of claim 11, further comprising the step of storing transaction information, wherein the transaction information further comprises at least one of a date the system user provided the subscriber identifier, the time the system user provided the subscriber identifier, and an indicator indicating whether or not the transaction authorization was provided.

14. The method of claim 11, further comprising prompting the system user for a pass code, and automatically notifying the authorized user if the pass code is incorrect.

15. The method of claim 11, further comprising storing transaction information corresponding to a plurality of transactions and providing the transaction information to the authorized user at a third location remote from the second location.

16. A distributed computing system for processing a credit card transaction, said computing system comprising:
a first computer-readable storage medium having computer-readable code stored thereon for directing a first computing device to process and transmit transaction information pertaining to a credit card from a first location to a second location through a communications network, wherein the transaction information includes a transaction amount and a subscriber identifier provided by a system user; and
a second computer-readable storage medium having computer-readable code stored thereon for directing a second computing device to
determine the identity of an authorized user of the credit card based upon the subscriber identifier,
establish a communications link with the authorized user,
provide to the authorized user through the established communications link the transaction amount and prompt the authorized user for a transaction authorization,
authorize the credit card transaction if the authorized user provides the transaction authorization, and
negate the credit card transaction if the authorized user does not provide the transaction authorization.

17. The distributed computing system of claim 16, wherein the second computer-readable storage medium has computer-readable code embedded therein for directing the second computing device to prompt the authorized user for a credit card selection and to charge the transaction amount to a user-selected credit card if the transaction authorization is provided.

18. The distributed computing system of claim 16, wherein the second computer-readable storage medium has computer-readable code embedded therein for directing the second computing device to store transaction information, wherein the transaction information further comprises at least one of a date the system user provided the subscriber identifier, the time the system user provided the subscriber identifier, and an indicator indicating whether or not the transaction authorization was provided.

19. The distributed computing system of claim 16, wherein the second computer-readable storage medium has computer-readable code embedded therein for directing the second computing device to prompt the system user for a pass code, and to automatically notify the authorized user if the pass code is incorrect.

20. The distributed computing system of claim 16, wherein the second computer-readable storage medium has computer-readable code embedded therein for directing the second computing device to store transaction information corresponding to a plurality of transactions and providing the transaction information to the authorized user at a third location remote from the second location.
